(19) United States
(12) Patent Application Publication
(10) Pub. No.: US 2010/0023350 A1
(43) Pub. Date: Jan. 28, 2010

(54) AUTO REGISTRATION OF NETWORK DEVICES

(75) Inventor: Daniel A. Simms, Sunnyvale, CA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/446,637

(22) PCT Filed: Oct. 16, 2007
(86) PCT No.: PCT/US07/81454

§ 371 Date: Apr. 22, 2009

Related U.S. Application Data
(60) Provisional application No. 60/862,620, filed on Oct. 24, 2006.

(51) Int. Cl. G06Q 50/00; H04L 9/32; H04L 29/06

(52) U.S. Cl. 705/3; 705/50; 726/10; 713/156

(57) ABSTRACT

Often when a patient is diagnosed with an ongoing or chronic health care condition, it is desirable to prescribe an ongoing treatment regimen to that patient. In this type of environment, a user interface device (12) performs a self registration and patient association over a public or private network (20) to avoid the process of having to be registered and associated in a factory setting. The interface device (12) contacts a registration server (32) over a public or private network (20) and presents factory-configured credentials. The registration server (32) upon proper authentication of the device (12) then directs the device (12) to a configuration server that will associate it with a particular patient or treatment regimen. One the patient's treatment is complete, the device (12) can be returned and re associated with another patient, effectively recycling the device (12).

The present application relates to network environments where a party runs a service that deploys and configures network devices. This concept is applicable to administering ongoing health care for patients with chronic illnesses or medical conditions. More specifically, the present application is directed to a secure, personalized platform service that connects patients and their care team enabling healthcare organizations to effectively and efficiently empower and assist their patients to manage their diseases and lifestyle.

Patients who have healthcare issues often have lifestyle issues which complicate the medical issues. For example, coronary disease can be aggravated by smoking, obesity, and the like. One system for helping these patients to manage their disease, adjust their lifestyle, and the like, provides each patient with personalized programming. The patient is provided with a series of educational or motivational programs directed to their specific healthcare issues. For example, the patient might be provided with educational and motivational programming at the same time each day to assist the patient in establishing and maintaining a diet and exercise regimen. The programming is provided on disc, from a programming memory, or from a central source, such as the hospital or medical care facility that has prescribed the programming and travels over a public communications network to the patient's home. There, a set top box decodes the signals intended for the specific patient and displays them on the patient's television. The set top box provides for user feedback, such as weigh-ins, blood pressure readings, and the like, to be communicated from the patient to the healthcare facility.

Although such systems are successful, one drawback is that the set top box or network device is preconfigured at the factory or other centralized location. Each network device is uniquely configured such that each patient can receive his/her own programming. Further, the network devices are configured to connect with the local server associated with the source of the prescribed healthcare programming. This pre-configuration requires a significant amount of labor and overhead to configure each network device and maintain records of each device's configuration.

The present application provides a new and improved method of auto-registration over a public network that overcomes the above-referenced problems and others.

In accordance with one aspect, a healthcare system is described. The system includes a public communications network, at least one registration server connected with the public communications network, and a plurality of configuration processors or servers connected with the public communications network. At least one programming source is connected with the public communications network for communicating patient-specific healthcare programming over the public network to a specific patient. Interface devices interface between the public communications network and a display. The interface devices are uniquely associated with a specific patient, and they include a registration and configuration processor or software. The processor or software is programmed to connect to the registration server via the public communication network when it is powered on. It then submits validation information to the registration server over the public communication network to establish the user interface device as authentic. Once the device has been authenticated, the processor or software receives a registration certificate from the registration server. After it receives the registration certificate, it connects to a designated one of the configuration servers or processors via the public communications network and, authenticates itself to the configuration processor or server using the registration certificate received from the registration server.

In accordance with another aspect, an interface device through which patient specific healthcare programming is received via a public communications network is described. Content from the interface device is displayed on a display device. The interface device includes a registration and configuration processor or software. The processor or software is programmed to connect to a registration server via the public communication network when it is powered on. It then submits validation information to the registration server over the public communication network to establish the user interface device as authentic. Next, it receives a registration certificate from the registration server. The interface device then connects to a designated configuration server or processor via the public communications network, and, authenticates itself to the configuration processor or server using the registration certificate received from the registration server.

In accordance with another aspect, a method of self registration and configuration in medical care giving system in which patient specific healthcare programming is supplied to a patient via user interface device is provided. The method includes connecting the user interface device with a source of electric power, a display, and a public communication network. The user interface device is then connected with a registration server via the public communications network. The user interface device submits validation information from to the registration server over the network establishing the user interface device as authentic. The registration server sends a registration certificate to the interface device. The interface device connects to a designated server or processor via the public communications network and authenticates itself by presenting the registration certificate received from the registration server to the server or processor.

In accordance with another aspect, a method of registering a medical care user interface device on a network is provided. The user interface device is connected to a public network. The registration server is contacted over the public network. The user interface device is then authenticated. The registration server issues a registration certificate to the user interface device that is stored by the user interface device. The user interface device then disconnects from the registration server.

In accordance with another aspect, a method of configuring a user interface device for association with a specific patient is provided. The device connects to a public network and presents a registration certificate gained from a registration server to a configuration server or processor. The configuration server or processor matches the user interface device with a specific patient. Patient specific programming is encrypted and sent to the user interface device over the public network. The programming is then decrypted in accordance with the specific configuration of the user interface device associated with the specific patient.

One advantage resides in less time lapse between program prescription and patient commencement of the program.

Another advantage resides in significant savings in cost.

Another advantage resides in ease of association of user devices with their users.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

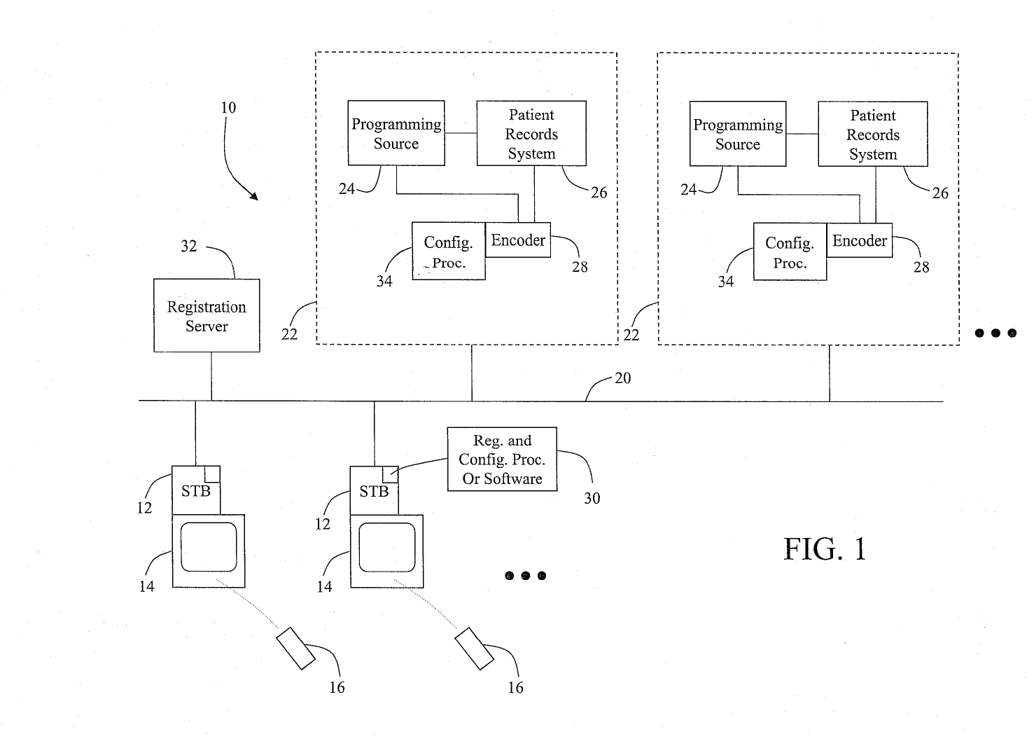

FIG. 1 is a diagrammatic illustration of a plurality of user interface devices and respective communications networks;

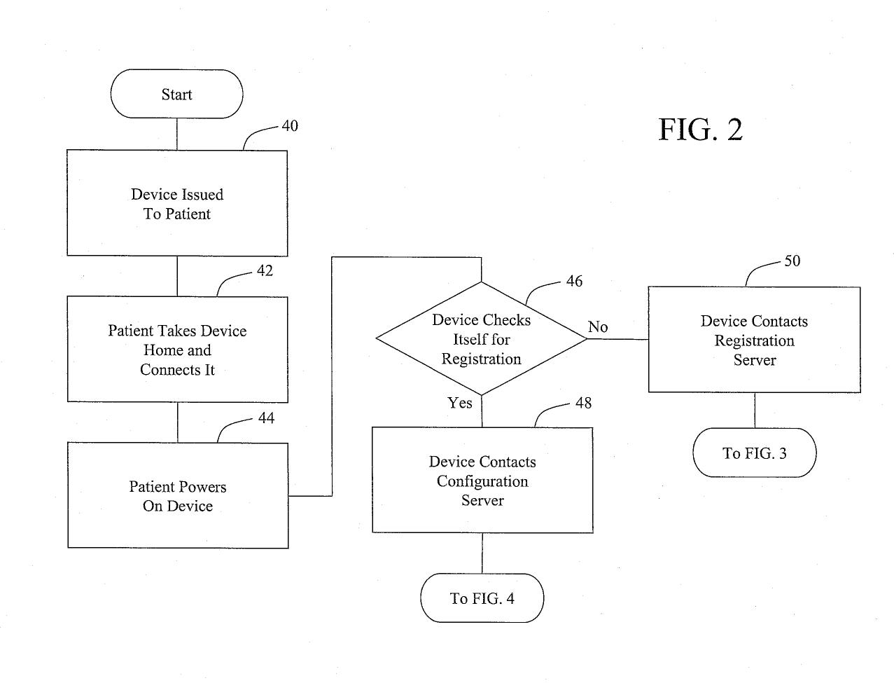

FIG. 2 is a flowchart depicting registration of a user interface device;

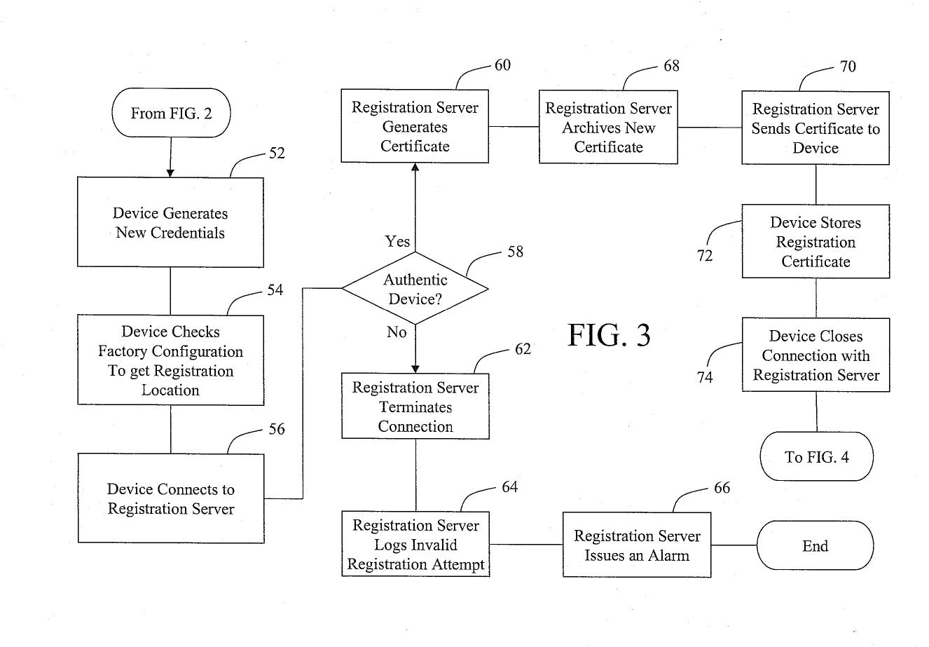

FIG. 3 is a continuation of the flowchart of FIG. 2;

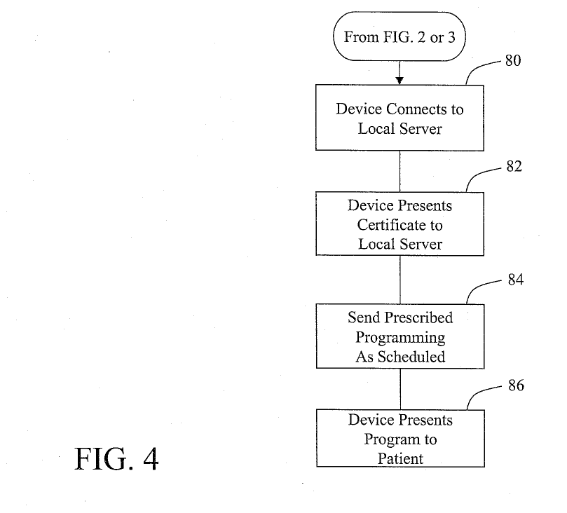

FIG. 4 is a continuation of the flowchart of FIGS. 2 and 3.

With reference to FIG. 1, a medical care network 10 is illustrated. When physicians prescribe short term care such as a finite amount of prescription drugs, rest, and the like, once the patient takes all the pills, etc., the treatment is complete. In many situations, however, the patient is diagnosed with a long term or chronic condition that can require long term care and/or lifestyle changes. In this type of situation, the healthcare professional may prescribe habits or behaviors that were not previously a part of the patient's daily regimen. The patient, motivated by his or her visit with the doctor, may start out with this new treatment with the best intentions, but as time lapses, it is easy to slip back into old habits. For instance, a patient may go to his doctor and be diagnosed with high cholesterol. The doctor recommends that the patient eat better and exercise more. Motivated by the newly perceived risk to his health, the patient goes on a diet and exercises. As time goes on, however, the patient starts to lapse back into his old behaviors, and eventually forgets diet and exercise. The healthcare network 10 is designed to help keep chronic care patients motivated, even long after any given visit to a doctor and to provide health related feedback from the patient to the caregiver.

The healthcare network 10 includes a plurality of individual user interface devices 12, such as a set top box, which is associated with a display 14, such as a user's television set. The interface 12 may be a separate set top box, or may be integrated into the display itself. The interface device also interacts with an input device 16, such as a handheld remote through which the patient can enter information, such as responses to questionnaires, health related readings such as weight or blood pressure, and the like.

The interface devices 12 connect or interface with a network 20, such as an interactive cable TV network, the internet, or the like. The network 20 in the preferred embodiment is a public network that is available for use by anyone. This type of network has the advantage of being accessible, but the disadvantage of being less secure. It is to be understood that other networks are also contemplated, such a controlled network wholly operated by a network provider who only opens it to their subscribers Through the network 20, the interface device 12 communicates with various servers such as local server 22 through which a programming source 24 provides the patient-specific programming for each patient as prescribed by a healthcare professional. For example, the prescribed healthcare regimen is stored in the patient's records in a patient record system 26 which accesses the program source to send or release a preselected or custom selected series of programming, questionnaires, and other information at selected times while the local server 22 to the patient's interface device 12 and display 14. In order to send or release the programming only to the designated patient and to identify the patient from which return information is received, a patient-specific encoding system 28 is associated with the local server 22 or programming source.

When the healthcare professional issues an interface device 12 to a specific patient, the interface device is unregistered and not configured. The patient or an assistant installs the interface device on the patient's TV or other display and to their interactive cable TV connection or other public network. When the user interface is connected to a power supply or otherwise powered up for the first time, a registration and configuration processor or software 30 controls the interface device to contact a registration server 32 from which it receives credentials to authorize and enable it to access one or more configuration servers or processors 34. The configuration processor 34 configures or otherwise establishes a uniquely encoded communication link between each interface device 12 and its assigned local server 22 and its patient-specific encoder 28.

With reference to FIG. 2, a flowchart illustrates more completely the process summarily outlined above. In a step 40, the patient is issued a set top box 12. The issuing healthcare professional may have set top boxes 12 in inventory available for distribution immediately, may direct the patient to a distribution center that is responsible for distributing new boxes, arrange for delivery, or the like. In this step, the healthcare professional, if personally issuing the set top box 12, can contact the registration server 32. For example, the issuer can tell the registration server that box number N was given to patient X so that the registration server knows to expect to be contacted by box N shortly. This way the registration server 32 will know to which local server 22 to direct the set top box. Other contacts with the registration server 32 are also contemplated.

Next, the patient takes possession of the set top box 12, takes it home and connects it to the network 10 in a step 42. In one embodiment, the set top box 12 connects to the Internet via a cable TV provider, but other wide area networks and connections are also contemplated. Next, the patient powers on the set top box 12 in a step 44. At step 46, the set top box 12 checks itself to see if it has been registered, e.g. whether it has a private key. If the set top box has already been registered, it can contact the appropriate local server 22 in a step 48. If, however, the set top box has not been registered, the registration and configuration processor or software 30 commences the registration process in step 50.

With reference now to FIG. 3, the registration of a set top box 12 is described. As soon as the set top box 12 discovers that it is not registered, the device accesses its factory installed credentials. In one embodiment, the credentials, such as a root certificate, can be used to authenticate itself to the registration server 32. In another embodiment, at a step 52, the device uses the factory installed credentials to generate new credentials such as a public/private key pair. Other methods of identity validation are also contemplated. Next, the set top box 12 checks its factory configuration to determine the location (e.g., IP address) of the registration server 32 in a step 54. In FIG. 1, one registration server 32 is shown. It is possible that there can be more than one registration server 32, each server 32 responsible for registering set top boxes 12 manufactured for use in its region, for example. Each set top box could also be assigned a primary registration server and in the multiple registration server embodiment, the set top boxes 12 could receive a region indicator as part of their factory configuration so that they know which registration server 32 to contact when first powered up.

The set top box 12 uses the address of its registration server 32, to connect that registration server 32 in a step 56. The set top box, in one embodiment, connects to the registration server 32 over a secure sockets layer (SSL) using a hypertext transfer protocol (HTTP) connection. This allows private information to be communicated back and forth between the set top box 12 and the registration server 32 over the network 20 without the risk of that information being compromised. Next, the registration server 32 authenticates the set top box 12 in a step 58. The set top box 12 submits its credentials to the registration server 32. For example, the set top box 12 sends the factory installed or generated credentials or other information to the registration server. If everything is in order, that is, if the set top box is authentic, the registration server 32 validates the registration request and generates a registration certificate for the set top box 12 in a step 60.

If the device is not authentic, the registration server 32 terminates the connection 62, and logs the unsuccessful registration attempt 64. It is also contemplated that the registration server 32 can issue an alarm or warning 66, to someone monitoring the registration server 32, and an investigation can be commenced if warranted. The registration server 32 can identify a non-authentic attempt to register in a number of ways. First, the device contacting the registration server 32 may provide an invalid set of configuration credentials. Alternately, the device may not present any credentials at all. Further, the device attempting to register may present factory credentials that the registration server 32 has already registered. This should not happen since no two set top boxes 12 should have the same registration credentials.

After the registration server 32 generates the certificate for the authenticated set top box 12, the registration server 32 archives the certificate at a step 68. This, among other things as noted above, helps the registration server identify non-authentic attempts to register. After archival of the certificate, the registration server 32 sends the certificate to the set top box 12 in a step 70. The set top box then stores the registration certificate 72. After the certificate is successfully transmitted and stored, the set top box 12 closes the connection with the registration server 32 in a step 74.

With reference to FIG. 4, communication between a set top box 12 and a configuration server 32 is described. A configuration server 34 in the one embodiment represents a hospital, one or more selected departments or sections of a hospital, network of hospitals, or a network of other care providers, such as family practices, clinics, or other care providers. After a set top box 12 has been registered (from step 74 in FIG. 3, or step 48 in FIG. 2), it contacts a configuration server 34 in a step 80. Once a set top box is connected with a configuration server 34, the set top box 12 identifies itself to the configuration server 34. In step 82, the set top box 12 presents its registration certificate to the configuration server 34. In one embodiment, the registration certificate contains a patient identification. In this embodiment, the configuration server 34 will immediately know what treatment regimen to download to the set top box 12. In another embodiment, the registration certificate only identifies the set top box and the patient is queried by the configuration server 34 to establish patient identification, typically by the software of the hospital or other entity represented by the configuration server 34. This can be as simple as the patient's name, social security number, hospital ID number, or the like. In another embodiment, the configuration server 34 may ask the patient to input a code given to them by the healthcare professional.

Once the patient is identified, the configuration server 34 is controlled to send or release prescribed programming and requests for health information to the patient at scheduled times 84. The programming can include education programming, motivational programming, and the like. More generally, however, the programming can also include any data going to or from the set top box 12. This includes command and control data being sent to or from an attached device, e.g., data for connected measurement devices or for controlled input/output devices. Additional types of programming can include status updates, messages to be logged, measurement data, or patient input data being sent to the local server 22. The health information can be requested by questionnaires that are answered using the remote controller 16 for the set top box 12 or other input device. Health information can also be supplied to the set top box 12 directly by electronic scales, blood pressure monitors, pulsometers, etc. Reminders of medical appointments and other information unique to the patient can also be communicated.

The same registration process can also be applied to the monitoring devices, such as the ones mentioned above, where the registration data can be routed through the set top box 12 once the set top box 12 is registered. This is beneficial to ensure that an entire system of measuring devices is accurately registered. The failure to register all of the devices completely can initiate a complete or partial data transmission block. With the current registration scheme, the entire system stays registered together as an added measure of security to the information being transmitted.

The material that is received from the configuration server 34 is presented to the patient as scheduled 86. The set top box 12 remains in communication with the configuration server 34 to receive program information on a regular basis. In one embodiment, program content is stored locally on the set top box 12, such as on a hard drive, flash memory, or other data storage device. In another embodiment, content is streamed in real time from the configuration server 34 to the set top box 12. In another embodiment, the set top box 12 downloads new content during off times, such as a day in advance of when the content is meant to be viewed by the patient.

If a patient completes his or her care regimen, or otherwise is no longer in need of the set top box 12, it is returned to the facility (doctor's office or distribution center) from which it originated. The set top box 12 can then be associated with another patient, or re-formatted with a new set of configuration credentials so that it may be registered again. In addition to the patient not needing the set top box 12 anymore, there may be other situations in which there may be a need or desire to reconfigure or re-register the set top box 12 and associated devices. This way, the set top boxes 12 can be re-used and are not tied eternally to a single patient.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A healthcare system comprising:
at least one registration server connectable to a public or private communications network;
a plurality of configuration processors or servers connected with the public or private communications network;
a plurality of interface devices which interface between the public or private communications network and a display, each interface device being uniquely associated with a specific patient, each interface device including a registration and configuration processor or software which is programmed to:
connect to the registration server via the public or private communication network when it is powered on;
submit validation information to the registration server over the public or private communication network to establish the user interface device as authentic;
receive a registration certificate from the registration server;
connect to a designated one of the configuration servers or processors via the public or private communications network; and
authenticate itself to the configuration processor or server using the registration certificate received from the registration server.

2. The healthcare system as set forth in claim 1, further including:
a programming source that encrypts the programming and sends it to the interface device.

3. The healthcare system as set forth in claim 1, further including:
a configuration server that stores medical records of the patient at a healthcare institution, the medical records associated to a patient to whom the interface device was assigned.

4. The healthcare system as set forth in claim 1, wherein the interface device further includes:
a registration analysis processor that checks the interface device to see if it is already registered.

5. The healthcare system as set forth in claim 1, wherein the configuration processor or server location includes:
an internet protocol memory that contains an internet protocol address of a healthcare institution that has prescribed patient-specific healthcare programming.

6. The healthcare system as set forth in claim 1, wherein interface device further includes:
a non-volatile memory that stores and submits validation information including at least one of a device ID and a root certificate.

7. The healthcare system as set forth in claim 1, wherein the interface device further includes:
a non-volatile memory that stores and submits validation information including factory configuration credentials.

8. The healthcare system as set forth in claim 1, wherein the interface device includes a communications processor that connects with a registration server over a secure sockets layer (SSL) via hypertext transfer protocol (HTTP).

9. The healthcare system as set forth in claim 1, wherein the interface device further includes:
a memory that stores the registration certificate issued by the registration server in the user interface device.

10. A communications system comprising:
at least one registration server connectable to a communications network;
a plurality of configuration processors or servers connected with the communications network;
a plurality of interface devices which interface between the communications network and a display, each interface device being uniquely associated with a specific user, each interface device including a registration and configuration processor or software which is programmed to:
connect to the registration server via the communication network when it is powered on;
submit validation information to the registration server over the communication network to establish the user interface device as authentic;
receive a registration certificate from the registration server;
connect to a designated one of the configuration servers or processors via the communications network, and,
authenticate itself to the configuration processor or server using the registration certificate received from the registration server.

11. An interface device through which patient specific healthcare or other programming information is received via a public or private communications network for display on a display device, the interface device including a registration and configuration processor or software programmed to:
connect to a registration server via the public or private communication network when it is powered on;
submit validation information to the registration server flyover the public or private communication network to establish the user interface device as authentic,
receive a registration certificate from the registration server;
connect to a designated one of a plurality configuration servers or processors via the public or private communications network; and
authenticate itself to the configuration processor or server using the registration certificate received from the registration server.

12. In a medical care giving system in which patient specific healthcare programming is supplied to a patient via user interface device, a method of self-registration and configuration of the user interface device comprising:
connecting the user interface device with a source of electric power, a display, and a public or private communication networks;
connecting the interface device with a registration server via the public or private communications network;
submitting validation information from the interface device to the registration server over the network establishing the user interface device as authentic;
sending a registration certificate from the registration server to the interface device;
connecting the interface device to a designated server or processor via the public or private communications network; and
authenticating the interface device to the server or processor using the registration certificate received from the registration server.

13. The method as set forth in claim 12, further including:
after the user interface device has been configured, sending patient-specific healthcare programming from a program source via the public or private communication network to the configured user interface device, the programming being encrypted to be received in accordance with the configuration of the user interface device.

14. The method as set forth in claim 12, further including:
via the interface device, the public or private communications network, and a configuration server, associating a patient to whom the interface device was assigned with medical records of the patient at the healthcare institution.

15. The method as set forth in claim 12, further including:
prior to connecting to the communications network, the user interface device checking itself to see whether it is already registered.

16. The method as set forth in claim 12, wherein the configuration server location includes an internet protocol address of a healthcare institution that has prescribed the patient-specific healthcare programming.

17. The method as set forth in claim 12, wherein the step of submitting validation information includes submitting at least one of a device ID and a root certificate.

18. The method as set forth in claim 12, wherein the step of submitting validation information includes submitting factory configuration credentials.

19. The method as set forth in claim 12, wherein the step of connecting with a registration server includes connecting to the registration server over a secure sockets layer (SSL) via hypertext transfer protocol (HTTP).

20. The method as set forth in claim 12, further including:
storing the registration certificate issued by the registration server in the user interface device.

21. The method as set forth in claim 12, wherein the registration server archives the registration certificate.

22. The method as set forth in claim 12, further including,
registering measurement devices that are peripheral devices to the user interface device concurrently with the user interface device.

23. A method of registering a medical care user interface device on a network comprising:
connecting the user interface device to a public or private network;
and performing the steps of:
presenting a registration certificate gained from a registration server to a configuration server or processor;
matching the user interface device with a specific patient;
encrypting patient specific programming in accordance with the configuration of the user interface device associated with the patient;
sending the encrypted patient specific programming over the public or private network; and
decrypting the patient specific programming encrypted for the specific patient in accordance with the specific configuration of the user interface device associated with the specific patient.

24. The method as set forth in claim 23 wherein the step of matching includes querying the patient as to his or her identity.
